(19) United States
(12) Patent Application Publication
(10) Pub. No.: US 2003/0135471 A1
(43) Pub. Date: Jul. 17, 2003

(54) Match control method

(76) Inventors: Jean-Luc Jaquier, La Conversion (CH); Marco Sasselli, Chardonne (CH)

Correspondence Address: Piper Rudnick, Supervisor Patent Prosecution Services, 1200 Nineteenth Street NW, Washington, DC, 20036-2412, US

(21) Appl. No.: 10/297,433

(22) PCT Filed: Dec. 19, 2001
(86) PCT No.: PCT/IB01/02603

(30) Foreign Application Priority Data
Dec. 22, 2000 (CH) 200 2519/00

(51) Int. Cl. G06F 17/60; H04L 9/00

(52) U.S. Cl. 705/67

(57) ABSTRACT

The objective of the present invention is to propose a method that guarantees the encryption of the exchanged data a security module and a user unit by a pairing key specific to the couple user unit/security module, and at the same time leaving the possibility for the security module to be paired with other user units.

According to the invention, this objective is achieved by a method consisting in:

detecting by the user unit if the connected security module is paired with it,

if it is so, using a unique pairing key specific to the couple user unit/security module to encrypt the exchanged data,

if it is not so, requesting the operating centre the authorisation to pair with this security module, a request accompanied by the identifications of the user unit and the security module,

verifying by the operating centre the conformity of this pairing request and transmitting the result to the user unit,

if the authorisation is given, establishing a pairing key unique to the couple user unit/security module to encrypt the exchanged data.

The present invention concerns a management method of secured information transfer between a user unit and a security module, particularly during the interaction of this security module with several user units.

These user units are connected to one or several networks proposing products or services.

These products or services being of conditional access, the use of these products is subject to a payment in any form, for example by subscription or specific purchase.

These user units are presented in several forms, for example a pay-television decoder, a computer, even a mobile phone, a palmtop, a PDA, a radio, a television, a multimedia station, an automatic teller machine.

By product or service we understand not only a film, a sports broadcasting, music, a computer programme, a game, stock market or news information but also a service such as access and use of a network, identification or electronic payment. This product or services are accessible on a network to which the users can connect and use encrypting means for security.

To administer the authorisations of use of these products or services the user unit comprises security means placed in a security module.

This security module is presented generally in the form of a smart card, a credit card, or a microprocessor, even a SIM, comprising a cryptographic processor (USIM, WIM). This card allows to supply the necessary information to authorise the use of the product by means of decrypting operations using keys stored in the memory of the cryptographic processor, reputed inviolable.

This security module is in charge of exchanging confidential information with the user unit, for example when transmitting the decrypting key of the product in the field of pay television, this key being decrypted in the security module and transmitted to the user unit to process the data.

This is why, to prevent any interference with these data, the communication means between the security module and the user unit is decrypted by a key specific to these two elements called pairing key. This configuration is described in the application PCT/IB99/00821 in which the specific key is initially in the decoder and is then charged in the security module during an initialisation phase. Once the security module is paired with the decoder this module cannot function in any other unit.

This solution presents the first inconvenience of preventing any use of the security module in another decoder, even if this decoder belongs to the same user. Another inconvenience of this method is that it does not prevent the use of a cloned card that would be used a first time in any decoder and then paired with this decoder.

The objective of the present invention is to propose a method that guarantees the decrypting of the data exchanged between the security module and the user unit at the same time avoiding the abovementioned inconveniences.

This objective is achieved by a pairing management method between a security module and a user unit, the latter having bi-directional communication means with an operating centre, characterised in that it consists in:

detecting by the user unit if the connected security module is paired with it,

if it is so, using a unique pairing key specific to the couple user unit/security module to encrypt the exchanged data,

if it is not so, requesting the operating centre the authorisation to pair with this security module, a request accompanied by the identifications of the user unit and the security module,

verifying by the operating centre the conformity of this pairing request and transmitting the result to the user unit,

if the authorisation is given, establishing a pairing key unique to the couple user unit/security module to encrypt the exchanged data.

In this way the pairing management is carried out in a dynamic way and is no longer the consequence of the connection of a security module in the user unit. It is administered by the operating centre, which decides to accept or refuse this pairing. This is why the request is accompanied by data allowing the identification of these two elements such as their serial numbers for example. It can be accompanied by data concerning the location of the unit, data obtained by other means, for example the call number of the unit or the address on its network.

By pairing key we understand a symmetrical or asymmetrical key, for example a public or a private key. In the latter case the three following cases may be presented:

each part comprises the two public and private keys. The communications towards the other part are encrypted by the public key and then decrypted by the private key.

each part contains one of the public or private keys. In one direction, the data will be encrypted by the public key and then decrypted by the private key, and in the other direction the data are encrypted by the private key and then decrypted by the public key.

each part contains the public key of the other part and its private key. The data are encrypted by the public key of the other part and decrypted by its own private key.

It should be noted that a security module can be paired with several user units. Its memory has a zone to store a group of pairing keys, each key being associated to the identification number of the user unit.

In this way, during each connection of such a module in a user unit the initialisation protocol includes the mutual recognition and use of the key (or keys) specific to the couple user unit/security module.

According to one embodiment, the user unit can equally have a pairing keys zone and due to this fact can be paired with several security modules.

This single key can be generated in several ways. It can be generated by the operating centre and transmitted with the pairing authorisation, well understood in encrypted form. This key is transmitted to the security module using an encryption established according to a session key according to known procedures.

Another means of obtaining this specific key is to generate it either in the user unit or in the security module or partially in each of these elements, the combination thus forming the key.

In one embodiment of the method of the invention, the request to the operating centre is accompanied not only by the identifying data of the couple user unit/security module but also by the data comprised in the pairing memory zone, that is including all the previous pairings.

The operating centre can then verify that this security module has been paired with the user units it has authorised, and according to the order of the requests.

In this way, if a security module has been cloned, when this cloned module demands to be paired with a user unit, the data transmitted to the operating centre concerning the previous pairings will be different to those of the original module. The operating centre, due to this fact, has means for identifying the cloned modules.

In a first time, the operating centre will accept the pairing of this cloned card with a new user unit B. If the cloning of an authentic card has been operated on a large scale, the next cloned card, having the same user identification, requesting the pairing with a new user unit C, the operating centre will not find any trace of a previous pairing with the user unit B. This indication will allow to detect an attempt of fraud and to react in consequence. Furthermore, if the user of the authentic card wants to use it with a new unit D, the pairing data transmitted by this module will not contain any trace of the unit C and the operating centre will refuse the pairing, and even will provoke the complete blocking of this security module.

1. A pairing management method between a security module and a user unit, the latter having bi-directional communication means with an operating centre, characterised in that it consists in:
detecting by the user unit if the connected security module is paired with it,
if it is so, using a unique pairing key specific to the couple user unit/security module to encrypt the exchanged data,
if it is not so, requesting the operating centre the authorisation to pair with this security module, this request being accompanied by the identifications of the user unit and the security module,
verifying by the operating centre the conformity of this pairing request and transmitting the result to the user unit,
if the authorisation is given, establishing a pairing key unique to the couple user unit/security module to encrypt the exchanged data.

2. A method according to claim 1, characterised in that the pairing key is either a symmetrical key, or an asymmetrical key, or a pair of asymmetrical keys.

3. A method according to claim 1 or 2, characterised in that it consists in storing in the security module the pairing key with the identification of the user unit.

4. A method according to claims 1 to 3, characterised in that it consists in transmitting the data of the previous pairings to the operating centre, the latter verifying these data with the image of authorised pairings associated with the user identification of this security module.

5. A method according to claims 1 to 4, characterised in that the pairing key is generated in the operating centre and is transmitted to the user unit and to the security module in encrypted form.

6. A method according to claims 1 to 5, characterised in that the pairing key is generated by the user unit or the security module, or by both of them.

7. A method according to any of the previous claims, characterised in that the user unit is a mobile phone and the security module is a SIM card.
